(19) United States
(12) Patent Application Publication
(10) Pub. No.: US 2007/0035626 A1
(43) Pub. Date: Feb. 15, 2007

(54) Interchangeable donut helmet apparatus

(75) Inventors: David Randall, Springfield, VA (US); Wayne Antesberger, Woodbridge, VA (US); Tomas Cincotta, Fairfax, VA (US)

Correspondence Address: DEPARTMENT OF THE ARMY;CECOM LEGAL OFFICE, FORT BELVOIR, AMSEL-LG-BELV, 10235 BURBECK ROAD, FORT BELVOIR, VA, 22060-5806, US

(73) Assignee: UNITED STATES OF AMERICA AS REPRESENTED BY THE DEPT OF THE ARMY

(21) Appl. No.: 11/053,712

(22) Filed: Jan. 31, 2005

(51) Int. Cl. H04N 7/18; H04N 5/30

(52) U.S. Cl. 348/158; 348/162

(57) ABSTRACT

For a helmet-mounted imaging system to be multi-purpose, effective, lightweight, and easy to use, it must be designed with the most advanced technologies, interchangeable and expandable for future upgrades. The Interchangeable Donut Helmet concept achieves this ability through the use illustrated in FIG. 1 of Section 5. These connected modules are attached around the perimeter of the helmet. An adjustable tensioner insures compatibility and a snug fit on similar helmets (FIG. 2). Each donut module is designed for a different use such as imaging camera, battery source, global positioning, or wireless transmitter. Images are transmitted wirelessly via radio frequencies (RF) (FIG. 3). A Helmet-Mounted Display (HMD) is incorporated on the front donut module in order for the wearer to view the camera image (FIG. 4). Each donut module consists of subsystems that incorporate low cost, lightweight and low power technologies. This provides the realization of a head-borne, low power and cost effective imaging system. Modularity promotes interchangeability that is simple and capable of various system configurations depending on the task. This system concept has firefighter and military applications.

### GOVERNMENT INTEREST

The invention described herein may be manufactured, used, sold, imported, and/or licensed by or for the Government of the United States of America.

### FIELD OF INTEREST

The invention relates to head mounted displays and more particularly to interchangeable head mounted displays that are capable of transmitting the displayed images via radio frequencies.

### BACKGROUND OF THE INVENTION

Thermal cameras can be manufactured as lightweight, low power devices with good performance through the advancements of infrared imaging and miniaturization of electronics. The distribution of these cameras to commercial, police, firefighting and military markets effectively lowers the cost per unit therefore making these systems also cost effective. Because of this miniaturization, it is now conceivable to physically mount these devices to a helmet, thereby freeing up the use of both hands. Current thermal cameras for firefighting applications are hand-held devices with narrow fields of view that limit both visibility and mobility. A helmet-mounted camera would significantly reduce these limitations.

Technologies exist for visible and infrared cameras, helmet mounted displays, compact batteries and RF transmitters. Military efforts are underway to combine these technologies into an integrated helmet-mounted system. An integrated system does not provide for interchangeability among similar sized/shaped helmets, therefore limiting its use to a single individual. The present invention provides this interchangeability among multiple helmet wearers.

### SUMMARY OF THE INVENTION

Accordingly, one object of the present invention is to provide an interchangeable helmet-mounted system for firefighter and/or military applications that are capable of visible and/or infrared imaging with wireless transmission of these images to a Helmet Mounted Display (HMD). The flexibility of the system and the adjustable tensioner provides complete interchangeability among similarly sized/shaped helmets. The inclusion of wireless technology provides the capability to transmit images of the wearer to other receivers for remote viewing. This system promotes increased performance, efficiency and effectiveness by the wearer for various activities such as mobility in limited visibility, reconnaissance and search and rescue. The use of infrared and wireless transmission insures functional operation in a broad range of environmental conditions.

### BRIEF DESCRIPTION OF THE DRAWINGS

These and other objects of the invention will become readily apparent in light of the Detailed Description Of The Invention and the attached drawings wherein:

FIG. 1 is a three dimensional drawing showing the invention mounted on a firefighter helmet;

FIG. 2 is a three dimensional view of the back portion of the present invention and its connection points.

FIG. 3 is a three dimensional view of the RF module of the present invention and its connection points.

FIG. 4 is a three dimensional view of the front portion of the present invention, including the camera element and the helmet mounted display, and its connection points.

FIG. 5 is a three dimensional view of the battery compartments of the present invention and their connection points.

### DETAILED DESCRIPTION OF THE INVENTION

The present invention integrates visible/infrared camera(s), a battery box, a Helmet-Mounted Display (HMD), and a wireless transmitter that collectively provide imaging and RF transmitting capabilities within a broad range of environmental conditions. The lightweight characteristics allow this unit to be attached to the helmet without burdening the user with excessive weight on the head and neck. The RF transmitter allows individuals without this system to also benefit from what the wearer sees.

The individual portions or compartments provide the ability to quickly and easily attach the system between helmets without compromising the integrity of the helmet. This allows more than one individual to use the same system.

The individual portions or compartments can be integrated with current and future task-specific technologies. By combining various portions or compartments into a complete, continuous system, it can be streamlined to particular tasks. This modularity enhances its expandability to incorporate future technologies and missions, and decreases the logistics burden on replacement of damaged subsystems. A device damaged during operation could be replaced with a similar portion or compartment onsite without delaying mission completion. This feature alleviates the logistics of shipping the entire system for repair of a particular subsystem, as is the case with fully integrated systems. It also has the added ability to combine subsystems from two damaged systems into one fully functional system.

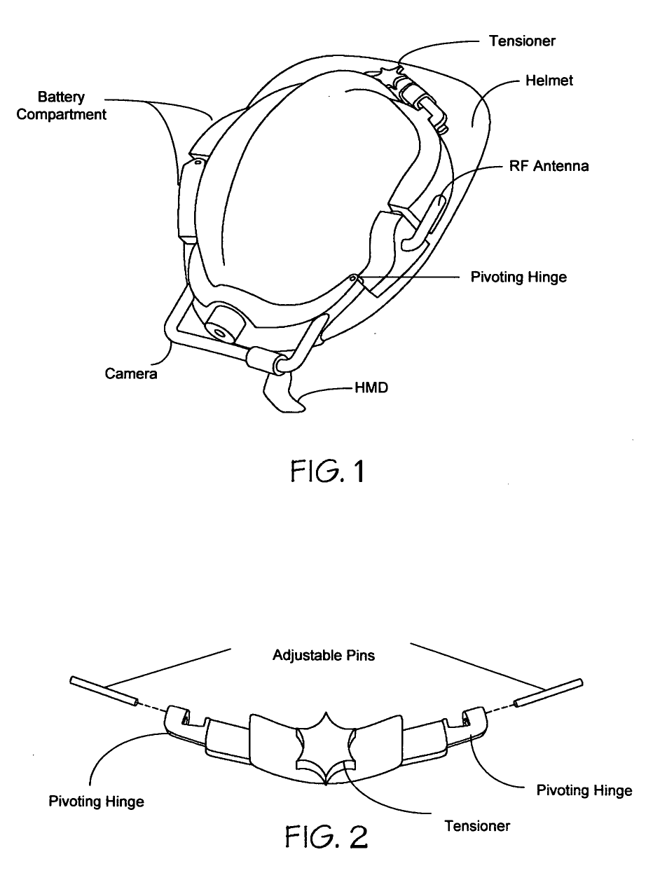

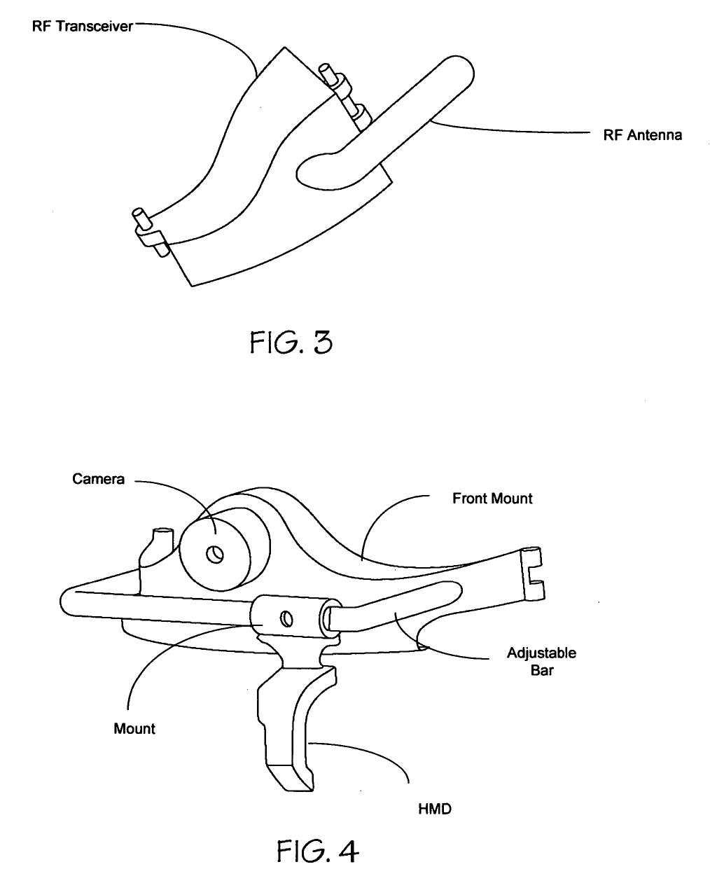

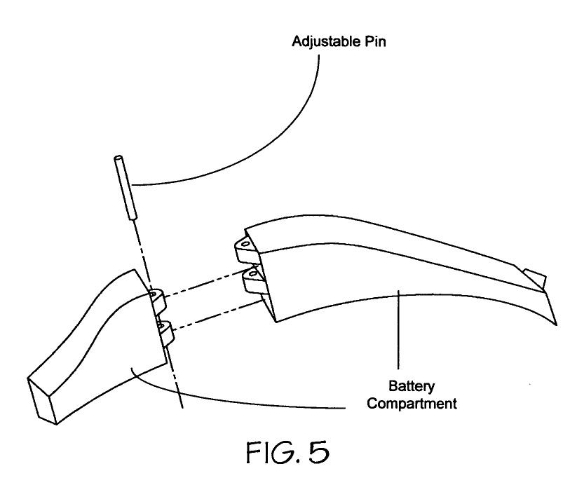

As shown in FIG. 1, the invention includes a front portion that holds the camera (image intensifying or thermal) and a bar upon which an HMD is mounted. The front portion (FIG. 4) is connected to the remainder of the system with pivoting hinges on either side. The front portion connects an RF transmitting compartment (FIG. 3) and battery compartments (FIG. 5), both of which wrap around the sides of the helmet and are connected via the pivoting hinges. The system is completed by a back portion, which has an adjustable tensioner to keep the whole system securely on the helmet (FIG. 2).

The individual donut portions or compartments can be fabricated to house specific devices such as a camera/imager or battery box. Power is provided by a battery box compartment (FIG. 5) designed to accommodate various combinations of portions or compartments connected in series. The front portion, which houses the camera, is fabricated with a front lip that attaches to the front lip of the helmet.

The portions or compartments are connected together by pins inserted through the hinges on opposite sides. The hinge points allow it to conform to the perimeter of any similar-sized helmet. Electrical connectors are used to transmit power, video and data across the individual portion or compartments. The lip on the front donut portion (FIG. 4) grabs the front of the helmet while the adjustable tensioner on the rear establishes a snug fit to the helmet (FIG. 2).

Once the system is attached to the helmet, operation begins with a touch of the power button. The horizontal bar on the front portion allows the HMD to be centered with either eye. (FIG. 4) For situations where the HMD is not necessary, it can be moved outside the wearer's vision by either a simple translation or rotation.

What is claimed is:

1. An interchangeable helmet mounted display apparatus comprising:
a front portion that houses a camera and that holds means for mounting a helmet mounted display on the front portion;
at least two pivoting side portions; and
a rear tensioner portion;
wherein the front portion, the at least two pivoting side portions, and the rear tensioner portion are all interchangeable as separate parts, wherein they are connected via similar connection means, and wherein the apparatus is removeable from the helmet.

2. The apparatus of claim 1 wherein the camera is an image intensifier camera.

3. The apparatus of claim 1 wherein the camera is a thermal image camera.

4. The apparatus of claim 1 wherein at least one of the two pivoting side portions compromises a battery compartment.

5. The apparatus of claim 1 wherein at least one of the two pivoting side portions compromises a radio frequency transmitter compartment.

6. The apparatus of claim 1 wherein the rear tensioner portion may apply more tension around the helmet by rotating an adjustable tensioner means.

7. The apparatus of claim 1 wherein the front portion has a lip that is securable to a front portion of a helmet.

8. The apparatus of claim 1 wherein the helmet mounted display is mounted on the bar so that it may be viewable by either eye and may be titled upward out of view completely.

9. The apparatus of claim 1 wherein the connection means are pivoting hinges.

10. The apparatus of claim 1 wherein the means for mounting a helmet mounted display on the front portion is a bar along which the helmet mounted display may moved.
